(19) United States
(12) Patent Application Publication
(10) Pub. No.: US 2008/0100740 A1
(43) Pub. Date: May 1, 2008

(54) METHODS AND APPARATUSES FOR ADJUSTING DIGITAL VIDEO SIGNALS

(75) Inventors: Tzu-Shiun LIU, Hsinchu County (TW); Hua WU, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/877,695

(22) Filed: Oct. 24, 2007

Related U.S. Application Data
(60) Provisional application No. 60/863,135, filed on Oct. 27, 2006.

(51) Int. Cl. H04N 7/01; H04N 11/20; H04N 9/64

(52) U.S. Cl. 348/443; 348/458; 348/720; 348/E09.037; 348/E07.003; 375/E07.198

(57) ABSTRACT

Methods for adjusting digital video signals, performed by an image generating device of a portable media player, are disclosed. A first signal adjustment unit reduces a resolution of a video frame to generate a reduced video frame by alternately dropping half of the scan lines of the video frame, and repeatedly drops scan lines after at least two scan lines until reaching the last scan line. The content of a first video frame is adjusted to a second video frame in response to a second signal adjustment unit before passing to the display module by the image generating device. The display module is directed to prevent adjustment of the second video frame by the first signal adjustment unit for generating a display video frame. The second video frame is adjusted by the second signal adjustment unit and output to the display module.

### CROSS REFERENCE TO RELATED APPLICATIONS

This application claims the full benefit and priority of provisional U.S. patent application Ser. No. 60/863,135, filed Oct. 27, 2006, entitled “Panel Related Project”, and incorporates the entire contents of said application herein.

### BACKGROUND

The invention relates to digital video, and more particularly, to methods and apparatuses for adjusting digital video signals.

Optical storage media may record 60 interlaced fields per second (or 30 full frames per second) for the NTSC (National TV Standards Committee) system. Each frame consists of 480 scan lines out of a total of 525 scan lines (the rest being used for other information such as sync data and captioning). Alternatively, the optical storage media may record 50 interlaced fields per second (or 25 full frames per second) for the PAL (Phase Alternating Line) system. When displaying the NTSC or PAL frames on a display panel with different scan line resolution, the NTSC or PAL frames must be adjusted without dramatically decreasing the quality of displayed images.

### SUMMARY

Methods for adjusting digital video signals, performed by an image generating device, e.g. a portable media player (PMP), are provided. The image generating device, e.g. a PMP, comprises a display module comprising a first signal adjustment unit, a second signal adjustment unit, and a display panel. The first signal adjustment unit reduces a resolution of a received video frame to generate a reduced video frame by alternately dropping half of the scan lines of the active region of the video frame, and repeatedly drops scan lines after at least two scan lines until reaching the last scan line of the active region of the reduced video frame. An embodiment of a method for adjusting digital video signals comprises the following steps. A first video frame is received. The content of an active region of the first video frame is adjusted to a second video frame in response to the second signal adjustment unit. The display module is directed to prevent adjustment of the second video frame by the first signal adjustment unit for generating a display video frame displayed on the display panel. The second video frame is output to the display module.

Methods for adjusting digital video signals, performed by a selection control unit of a display module of a PMP (portable media player) or other image generating devices, are provided. The display module comprises a selector, a first signal adjustment unit, and a second signal adjustment unit. The selection control unit is connected to the selector, and the selector is connected to the first and second signal adjustment units. An embodiment of a method for adjusting digital video signals comprises the following steps. A video frame is received. A quantity of active scan lines of an active region of the video frame is acquired from the video frame. The first signal adjustment unit or the second signal adjustment unit is determined contingent upon the acquired quantity. The selector is directed to transfer the video frame to the determined signal adjustment unit.

Apparatuses for adjusting digital video signals are provided. An embodiment of an apparatus comprises a display module and an image generating device. The display module comprises a first signal adjustment unit, a second signal adjustment unit, and a display panel. The image generating device connected to the display module, receives a first video frame, adjusts the content of an active region of the first video frame to a second video frame in response to a second signal adjustment unit, directs the display module to prevent adjustment of the second video frame by the first signal adjustment unit for generating a video frame displaying on the display panel, and outputs the second video frame to the display module. The first signal adjustment unit reduces a resolution of a received video frame to generate a reduced video frame by alternately dropping half of the scan lines of the active region of the video frame, and repeatedly drops scan lines after at least two scan lines until reaching the last scan line of the active region of the reduced video frame.

An embodiment of an apparatus comprises a first signal adjustment unit, a second signal adjustment unit, a selector, and a selection control unit. The selector is connected to the first and second signal adjustment units. The selection control unit connects to the selector, receives a video frame, and acquires a quantity of active scan lines of an active region of the video frame from the video frame. The selection control unit determines the first signal adjustment unit or the second signal adjustment unit contingent upon the acquired quantity, and directs the selector to transfer the video frame to the determined signal adjustment unit.

### BRIEF DESCRIPTION OF THE DRAWINGS

The invention can be more fully understood by reading the subsequent detailed description and examples with references made to the accompanying drawings, wherein:

FIG. 1 is a diagram of an embodiment of a PMP (portable media player) connecting to a TV (television) via a cable;

FIG. 2 is a diagram of the hardware architecture of an embodiment of a PMP;

FIG. 3 shows the hardware architecture of an embodiment of control circuits;

FIG. 4 is a diagram illustrating an exemplary display frame generated from a reduced video frame by dropping the uppermost three and the lowermost three scan lines;

FIG. 5 is a diagram illustrating an exemplary display frame generated from a reduced video frame by repeatedly dropping one scan line after six scan lines until reaching the last scan line;

FIG. 6 shows the hardware architecture of an embodiment of control circuits;

FIG. 7 is a flowchart illustrating an embodiment of a method for adjusting digital video signals, performed by an image generating device;

FIG. 8 is a diagram illustrating an exemplary display frame generated from a video frame;

FIG. 9 is a flowchart illustrating an embodiment of a method for adjusting digital video signals, performed by an image generating device;

FIG. 10 is a diagram illustrating an exemplary display frame generated from a video frame;

FIG. 11 shows the hardware architecture of an embodiment of control circuits;

FIG. 12 is a flowchart illustrating an embodiment of a method for adjusting digital video signals, performed by an image generating device;

FIG. 13 is a diagram of an exemplary video stream of a video frame encoded in the CCIR 656 format;

FIG. 14 is a flowchart illustrating an embodiment of a method for adjusting digital video signals, performed by an image generating device.

### DETAILED DESCRIPTION

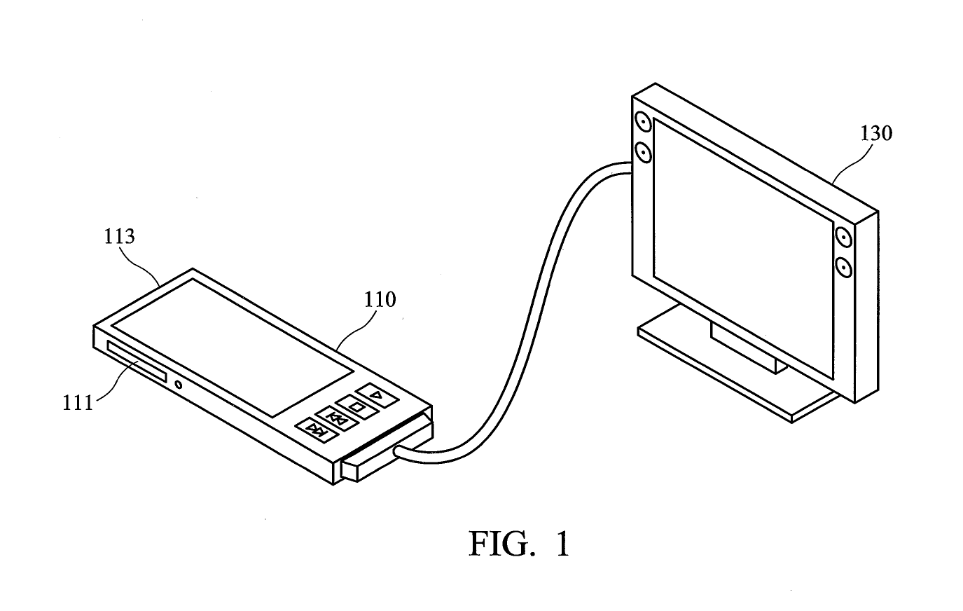

FIG. 1 is a diagram of an embodiment of a PMP (portable media player) 110 connecting to a TV (television) 130 via a cable. Please be noted that PMP is used as an example, instead of a limitation. The PMP 110 comprises an optical drive 111 and a LCD (liquid crystal display) panel 113. The optical drive 111 loads optical storage media, such as a VCD or DVD disc, to acquire video frames therefrom for playback and displays the acquired video frames on the LCD panel 113. The acquired video frames may further be simultaneously output to the TV 130 for display. The optical storage media may record 60 interlaced fields per second (or 30 full frames per second) for the NTSC (National TV Standards Committee) system. Each frame consists of 480 scan lines out of a total of 525 scan lines (the rest being used for other information such as sync data and captioning). Note that an active region of a frame is composed of the 480 scan lines. Alternatively, the optical storage media may record 50 interlaced fields per second (or 25 full frames per second) for the PAL (Phase Alternating Line) system. Each frame consists of 576 scan lines out of a total of 625 scan lines (the rest being used for other information such as sync data and captioning). Note that an active region of a frame is composed of the 576 scan lines. Other display panels may be disposed in the PMP 110 to display video frames, such as an OLED (organic light-emitting diode) panel, or similar.

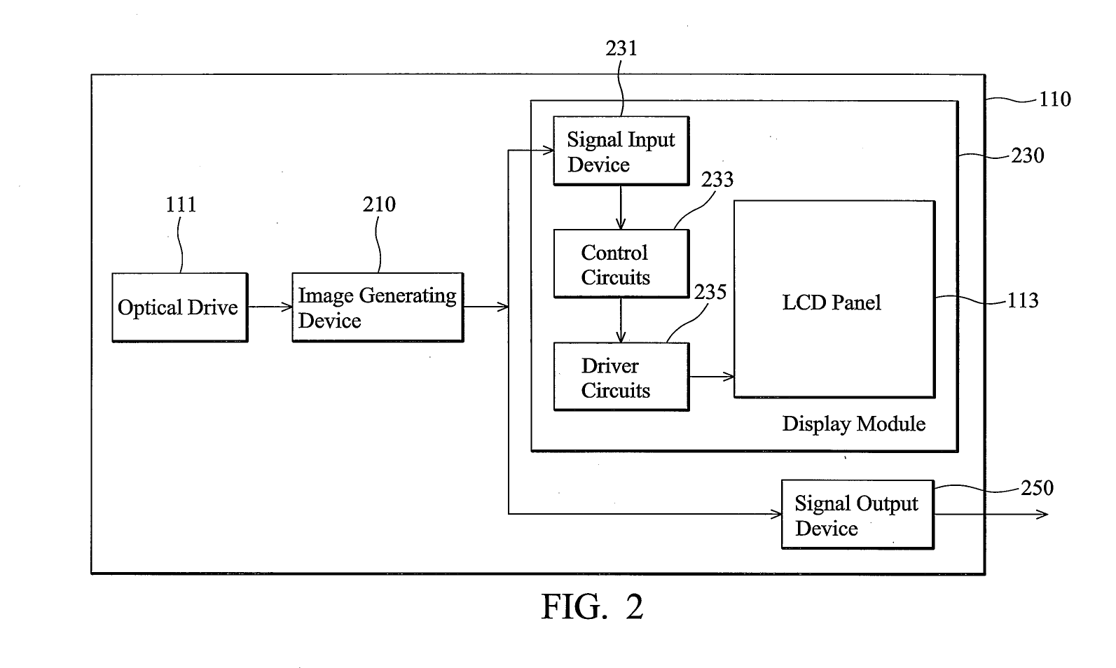

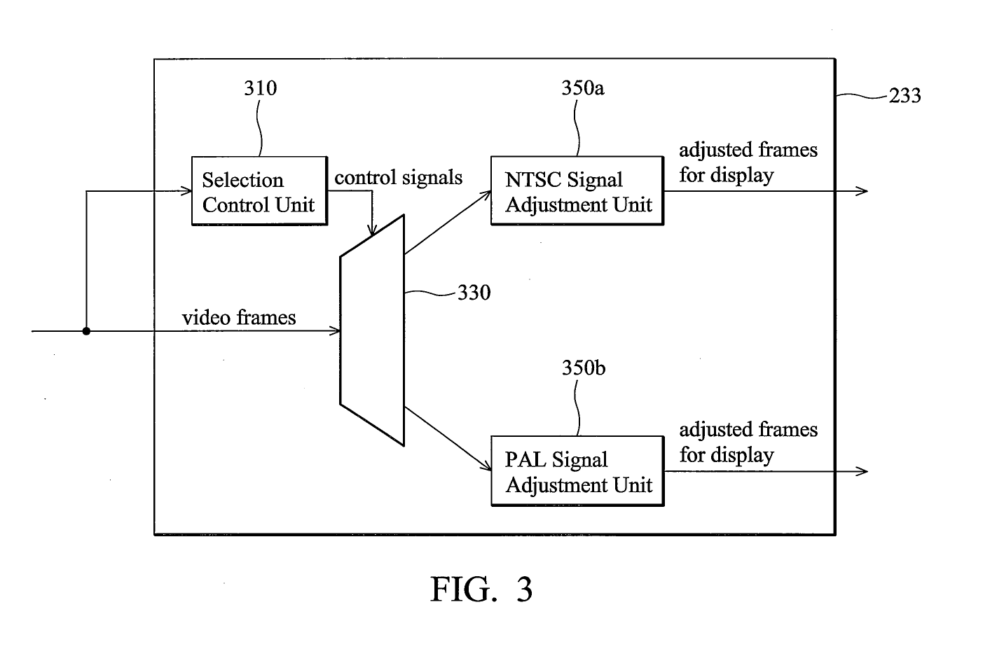

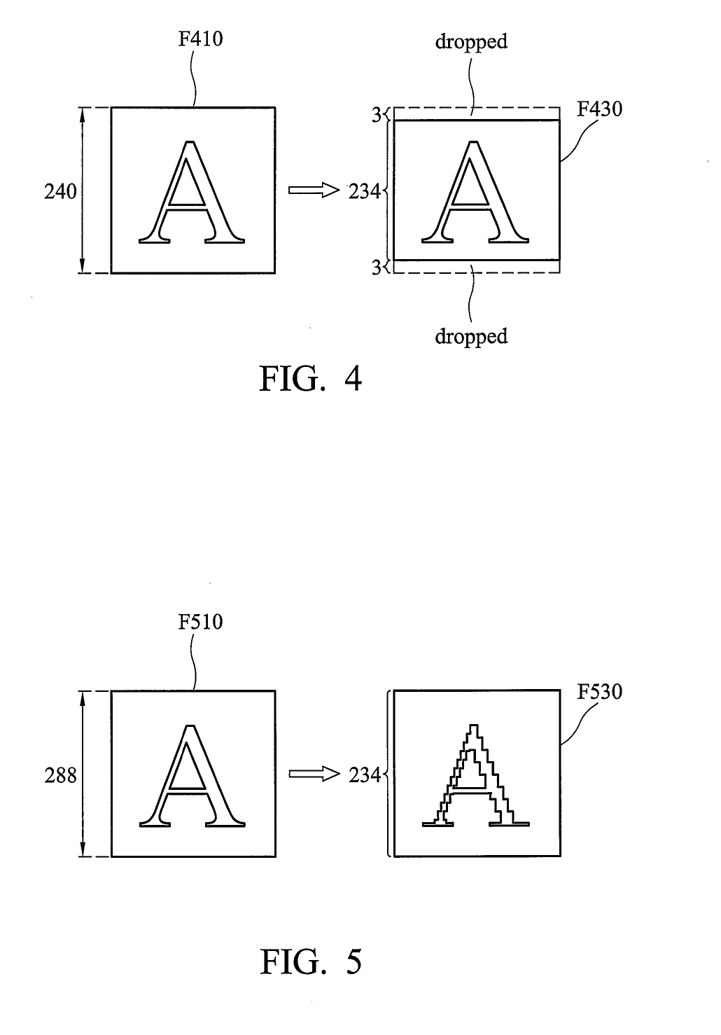

FIG. 2 is a diagram of the hardware architecture of an embodiment of the PMP 110 comprising the optical drive 111, an image generating device 210, a display module 230, and a signal output device 250. The display module 230 comprises a signal input device 231, control circuits 233, driver circuits 235, and an LCD panel 113. An embodiment of the LCD panel 113 comprises 234 lines for displaying frames. In order to reduce hardware cost, the image generating device 210 receives video frames from the optical drive 111, and processes and outputs the acquired video frames to both the display module 230 and the signal output device 250. FIG. 3 shows the hardware architecture of exemplary control circuits 233 comprising a selection control unit 310, a selector 330, a NTSC signal adjustment unit 350a, and a PAL signal adjustment unit 350b. This is not prior art for purposes of determining the patentability of the invention and merely shows a problem found by the inventors. The selection control unit 310 receives video frames from the signal input device 231 (FIG. 2), determines whether the acquired video frames conform to the NTSC system or the PAL system by inspecting a V-sync signal therein. Control signals are issued to direct the selector 330 to transfer the received video frames to the NTSC signal adjustment unit 350a, or the PAL signal adjustment unit 350b. For example, upon detecting a V-sync signal of 60 Hz, the selection control unit 310 issues control signals to direct the selector 330 to transfer the received video frames to the NTSC signal adjustment unit 350a. Upon detecting a V-sync signal of 50 Hz, the selection control unit 310 issues control signals to direct the selector 330 to transfer the received video frames to the PAL signal adjustment unit 350b. The NTSC signal adjustment unit 350a reduces a resolution of an active region for each frame by alternately dropping half of the scan lines, and then generates and displays an adjusted video frame comprising an active region containing 234 scan lines on the LCD panel 113 (FIG. 2) by dropping the upper three and lower three scan lines for each reduced video frame. FIG. 4 is a diagram illustrating an exemplary display frame F430 generated from a reduced video frame F410 by dropping uppermost three and the lowermost three scan lines. The PAL signal adjustment unit 350b reduces a resolution of an active region for each frame by alternately dropping half of the scan lines for each frame, and then generates and displays an adjusted video frame comprising an active region containing 234 scan lines on the LCD panel 113 (FIG. 2) by repeatedly dropping one scan line after certain scan lines, such as six scan lines, until reaching the last scan line. FIG. 5 is a diagram illustrating an exemplary display frame F530 generated from a reduced video frame F510 by repeatedly dropping one scan line after six scan lines until reaching the last scan line. It is to be understood that display image F430 (FIG. 4) is smoother than display image F530 (FIG. 5). Thus, the NTSC signal adjustment unit 350a generates display frames from the received video frames with better quality, while the PAL signal adjustment unit 350b generates display frames with worse quality. That is, the NTSC signal adjustment unit 350a generates results more suitable to the LCD panel 113.

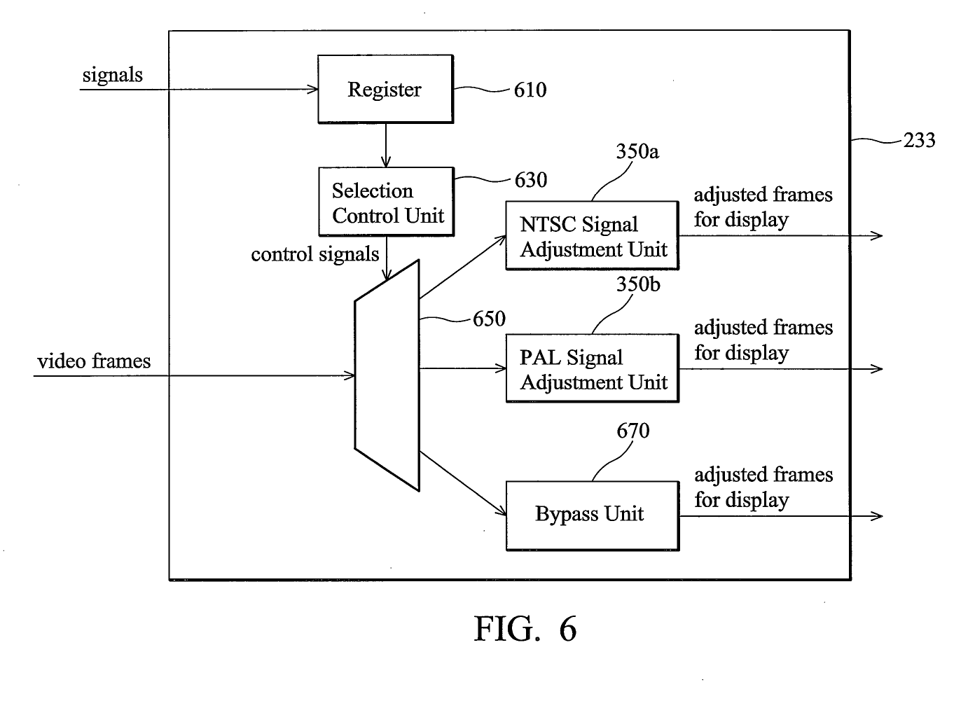

FIG. 6 is the hardware architecture of an embodiment of control circuits 233 comprising a register 610, a selection control unit 630, a selector 650, the NTSC signal adjustment unit 350a, the PAL signal adjustment unit 350b, and a bypass unit 670. The selection control unit 610 acquires information indicating that the NTSC signal adjustment unit 350a, the PAL signal adjustment unit 350b, or the bypass unit 670 has been enabled to process the received video frames from the register 610, and issues control signals to direct the selector 330 to transfer the received video frames to the NTSC signal adjustment unit 350a, the PAL signal adjustment unit 350b, or the bypass unit 670 according to the acquired information. For example, when the acquired information indicates that the NTSC signal adjustment unit 350a has been enabled to process the received video frames, the selection control unit 310 issues control signals to direct the selector 330 to transfer the received video frames to the NTSC signal adjustment unit 350a. The remaining controls performed by the selection control unit 310 can be deduced by analogy. Description of the NTSC signal adjustment unit 350a is provided with reference to FIGS. 3 and 4. Description of the PAL signal adjustment unit 350b is provided with reference to FIGS. 3 and 5. The bypass unit 670 reduces a resolution of an active region for each frame by alternately dropping half of the scan lines to generate and display an adjusted video frame comprising an active region containing 234 scan lines, acquired from the beginning scan line, on the LCD panel 113 (FIG. 2).

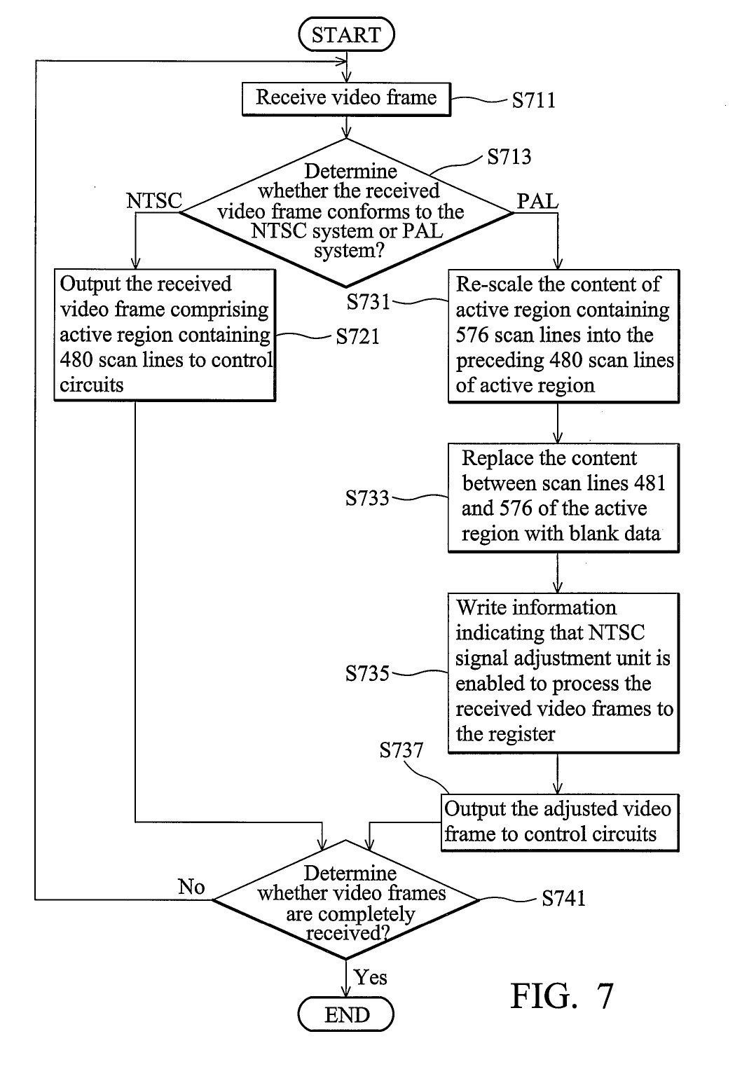

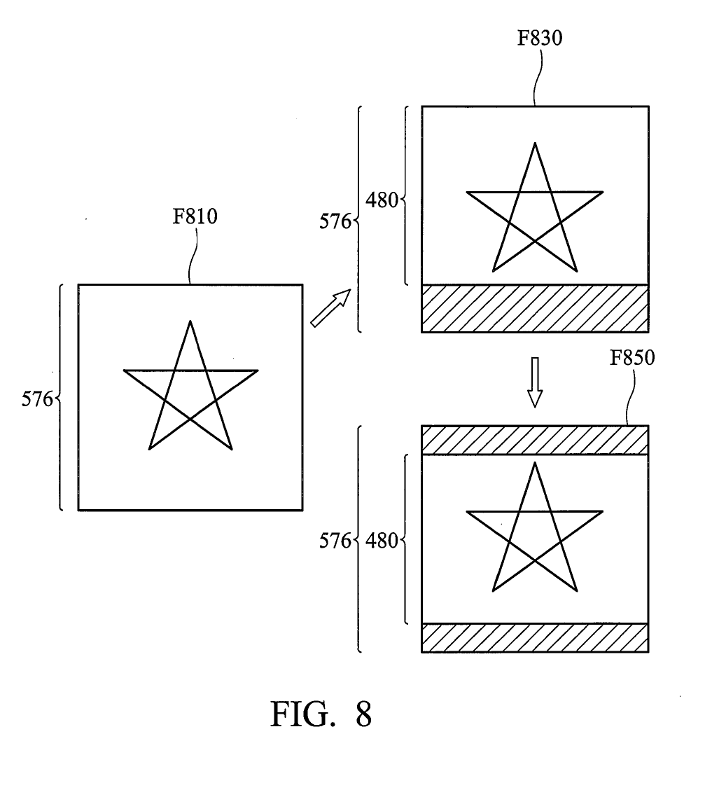

FIG. 7 is a flowchart illustrating an embodiment of a method for adjusting digital video signals, performed by the image generating device 210 (FIG. 2), with reference to the control circuits 233 of FIG. 6. A loop comprising steps S711 to S741 is repeatedly executed for processing the received video frames from the optical drive 111 (FIG. 2). In step S711, a video frame is received from the optical drive 111. In step S713, it is determined whether the received video frame conforms to the NTSC system or PAL system. If the received video frame conforms to the NTSC system, the process proceeds to step S721, otherwise, to step S731. In step S721, the received video frame comprising an active region containing 480 scan lines is output to the control circuits 233 of FIG. 6. In step S721, information indicating that the NTSC signal adjustment unit 350a is enabled for processing the received video frames may also be written to the register 610 of FIG. 6 prior to outputting the received video frame. In step S731, the content of an active region containing 576 scan lines is re-scaled into the preceding 480 scan lines of the active region by various scaling algorithms. A scaling algorithm may use mathematic interpolation, weighted averaging, or similar operations to regenerate pixel data (e.g. luma and/or chroma) in one target scan line (i.e. one of 480 scan lines) with reference to a certain number of original scan lines (i.e. at least two of 576 scan lines). Note that the scaling algorithm consumes excessive storage capacity to cache the original and target scan lines when re-scaling. The storage capacity is not provided in the control circuits 233 of FIG. 6 in order to reduce hardware cost. In step S733, the content between scan lines 481 and 576 of the active region are replaced with blank data. In step S735, information indicating that the NTSC signal adjustment unit 350a of FIG. 6 is enabled to process the received video frames is written to the register 610 of FIG. 6. In step S737, the adjusted video frame is output to the control circuits 233 of FIG. 6 for further processing. Note that, in step S737, the adjusted video frame is also output to the signal output device 250 of FIG. 2. The signal output device 250 adjusts the received video frame to place the re-scaled content in the center of the video frame upon detecting that the received video frame conforms to the PAL system, and subsequently transforms the adjusted results into TV signals, and transmits the TV signals to a TV. FIG. 8 is a diagram illustrating an exemplary display frame F830 generated from a video frame F810 after performing steps S731 and S733, and an exemplary display frame F850 adjusted from the display frame F830 by the signal output device 250.

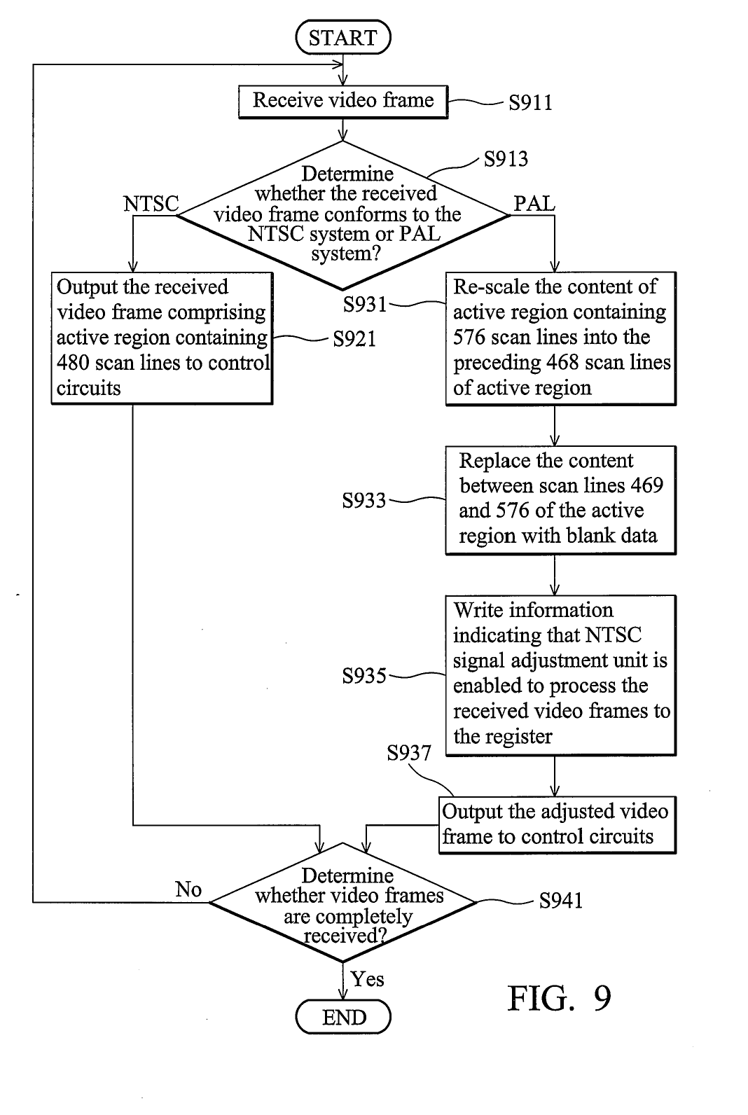

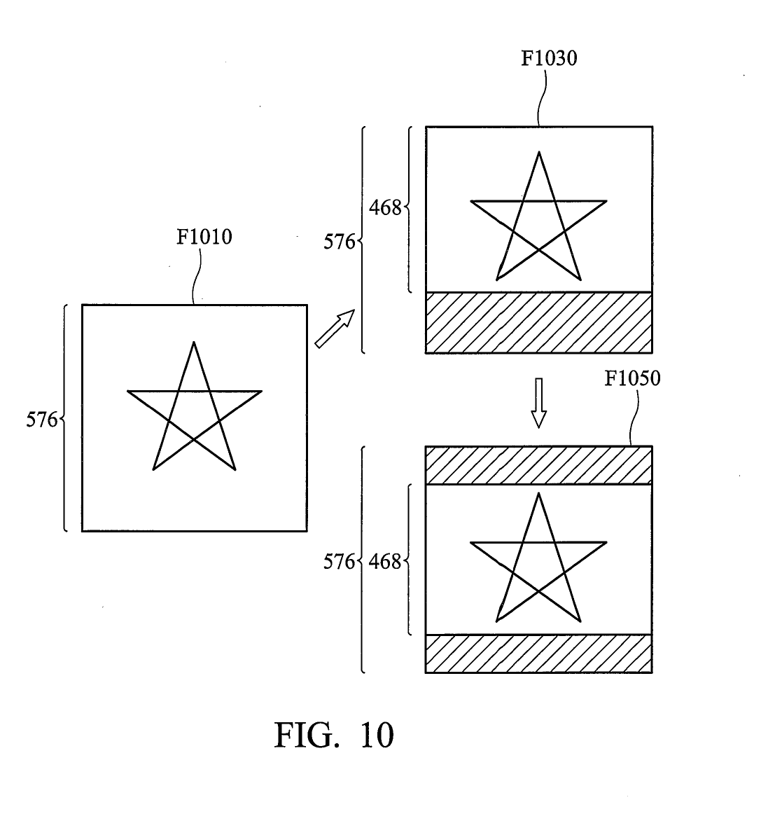

FIG. 9 is a flowchart illustrating an embodiment of a method for adjusting digital video signals, performed by the image generating device 210 (FIG. 2), with reference to the control circuits 233 of FIG. 6. A loop comprising steps S911 to S941 is repeatedly executed for processing the received video frames from the optical drive 111 (FIG. 2). In step S911, a video frame is received from the optical drive 111. In step S913, it is determined whether the received video frame conforms to the NTSC system or PAL system. If the received video frame conforms to the NTSC system, the process proceeds to step S921, otherwise, to step S931. Description of step S921 follows step S721 of FIG. 7. In step S931, the content of an active region containing 576 scan lines is re-scaled into the preceding 468 scan lines of the active region by the described scaling algorithms. In step S933, the content of scan lines 469 to 576 of the active region are replaced with blank data. In step S935, that the bypass unit 670 of FIG. 6 is enabled for processing the received video frames is written to the register 610 of FIG. 6. In step S937, the adjusted video frame is output to control circuits 233 of FIG. 6 for further processing. Note that, in step S937, the adjusted video frame is also output to the signal output device 250 of FIG. 2. The signal output device 250 adjusts the received video frame to place the re-scaled content in the center of the video frame upon detecting that the received video frame conforms to the PAL system, and subsequently transforms the adjusted results into TV signals transmitted to a TV. FIG. 10 is a diagram illustrating an exemplary display frame F1030 generated from a video frame F1010 after performing steps S931 and S933, and an exemplary display frame F1050 adjusted from the display frame F1030 by the signal output device 250.

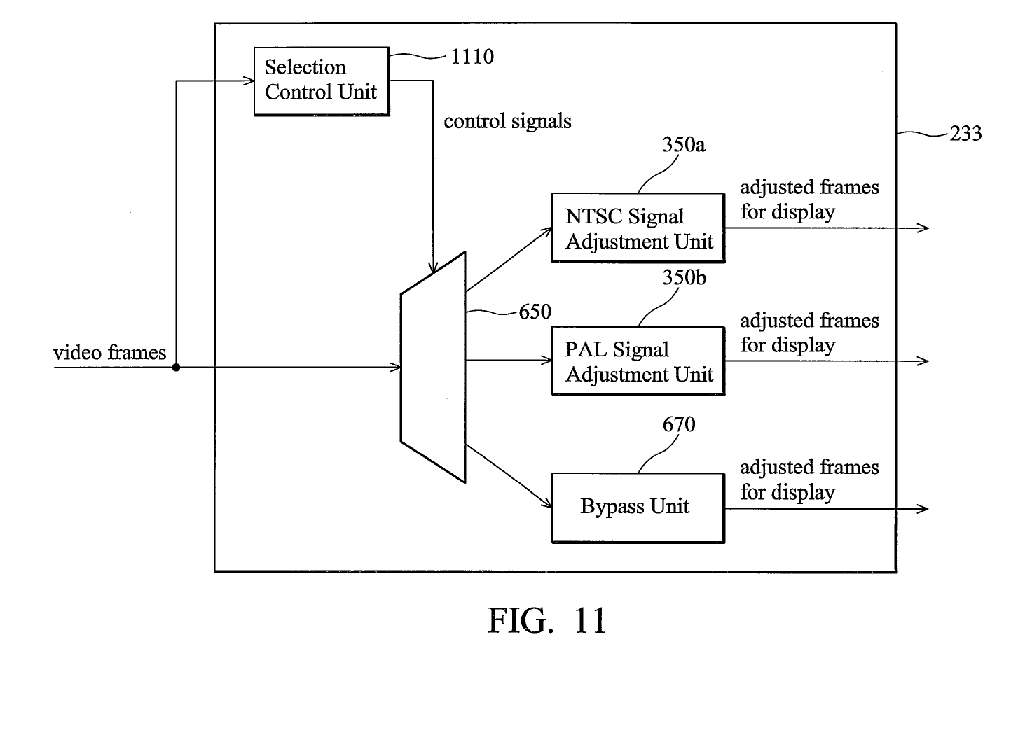

FIG. 11 is the hardware architecture of an embodiment of control circuits 233 comprising a selection control unit 1110, the selector 650, the NTSC signal adjustment unit 350a, the PAL signal adjustment unit 350b, and the bypass unit 670. The selection control unit 1110 receives video frames, acquires quantities of active scan lines of active regions thereof, and issues control signals to direct the selector 650 to transfer the received video frames to the NTSC signal adjustment unit 350a, the PAL signal adjustment unit 350b, or the bypass unit 670 according to the calculated quantities. Generating quantities of active scan lines is only briefly described here. For example, when a quantity of active scan lines of active regions thereof is 480, the selection control unit 1110 issues control signals to direct the selector 650 to transfer the received video frames to the NTSC signal adjustment unit 350a. When a quantity of active scan lines of active regions thereof is 576, the selection control unit 1110 issues control signals to direct the selector 650 to transfer the received video frames to the PAL signal adjustment unit 350b. When a quantity of active scan lines of active regions thereof is 468, the selection control unit 1110 issues control signals to direct the selector 650 to transfer the received video frames to the bypass unit 670. Description of the NTSC signal adjustment unit 350a may follow the description of FIGS. 3 and 4. Description of the PAL signal adjustment unit 350b may follow the description of FIGS. 3 and 5. Description of the bypass unit 670 may follow the description of FIG. 6.

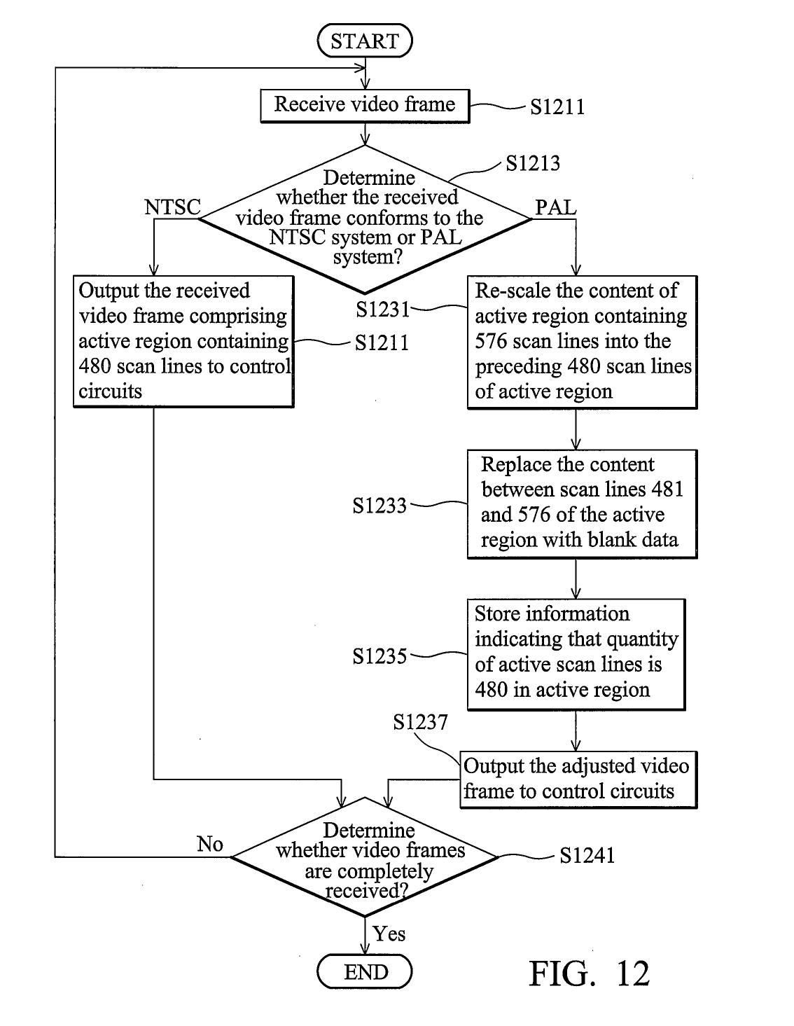

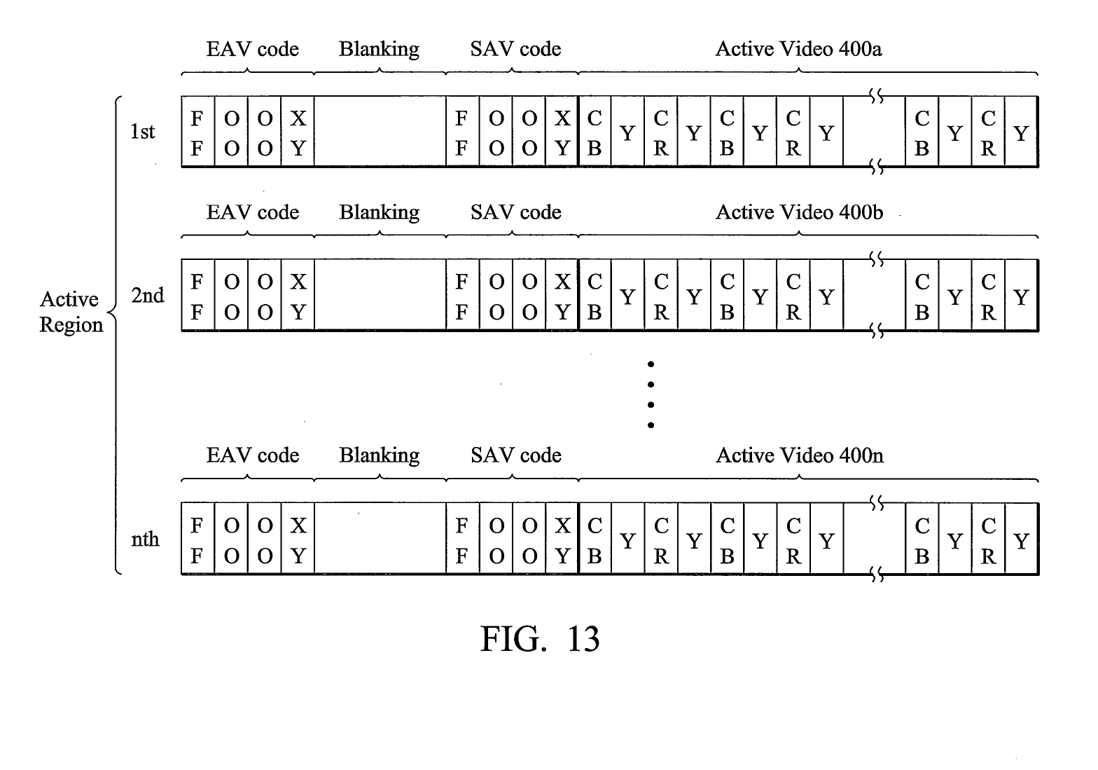

FIG. 12 is a flowchart illustrating an embodiment of a method for adjusting digital video signals, performed by the image generating device 210 (FIG. 2), with reference to the control circuits 233 of FIG. 11. A loop comprising steps S1211 to S1241 is repeatedly executed for processing the received video frames from the optical drive 111 (FIG. 2). In step S1211, a video frame is received from the optical drive 111. In step S1213, it is determined whether the received video frame conforms to the NTSC system or PAL system. If the received video frame conforms to the NTSC system, the process proceeds to step S1221, otherwise, to step S1231. In step S1221, the received video frame comprising an active region containing 480 scan lines is output to the control circuits 233 of FIG. 6. In step S1221, it may also store information indicating that a quantity of active scan lines is 480 in the active region prior to outputting the received video frame. In step S1231, the content of an active region containing 576 scan lines is re-scaled into the preceding 480 scan lines of the active region by the described scaling algorithms. In step S1233, the content between scan lines 481 to 486 of the active region are replaced with blank data. In step S1235, information indicating that a quantity of active scan lines is 480 is stored in the active region. It is to be understood the adjusted video frame may be formatted in the CCIR 656 format. FIG. 13 is a diagram of an exemplary video stream of a video frame encoded in the CCIR 656 format, comprising data of n scan lines, where n represents a total number of scan lines in an active region. Each line is divided into four portions, end of active video (EAV) code, blanking, start of active video (SAV) code and active video. The active video portion such as one of 400a to 400n stores pixel data of one line. Referring to FIG. 12, in step S1235, all enabled bits in SAV codes of the preceding 480 scan lines of an active region are set to “1”, and all enabled bits in SAV codes of scan lines 481 to 576 of the active region are set to “0”. Thus, the selection control unit 1110 of FIG. 11 can acquire a quantity of active scan lines by counting the enabled bits in SAV codes of an active region. In step S1237, the adjusted video frame is output to the control circuits 233 of FIG. 11 for further processing. Note that, in step S1237, the adjusted video frame is also output to the signal output device 250 of FIG. 2.

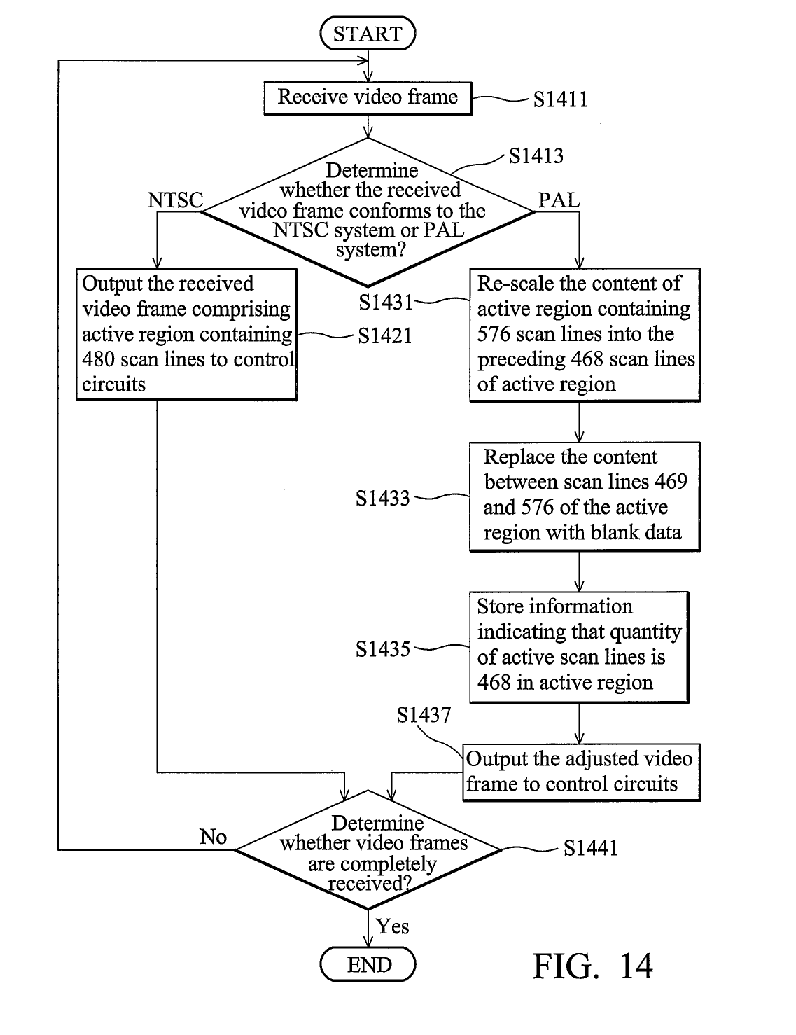

FIG. 14 is a flowchart illustrating an embodiment of a method for adjusting digital video signals, performed by the image generating device 210 (FIG. 2), with reference to the control circuits 233 of FIG. 11. A loop comprising steps S1411 to S1441 is repeatedly executed for processing the received video frames from the optical drive 111 (FIG. 2). In step S1411, a video frame is received from the optical drive 111. In step S1413, it is determined whether the received video frame conforms to the NTSC system or PAL system. If the received video frame conforms to the NTSC system, the process proceeds to step S1421, otherwise, to step S1431. In step S1421, the received video frame comprising an active region containing 480 scan lines is output to the control circuits 233 of FIG. 6. In step S1421, it may also store information indicating that a quantity of active scan lines is 480 in the active region prior to outputting the received video frame. In step S1431, the content of an active region containing 576 scan lines is re-scaled into the preceding 468 scan lines of the active region by the described scaling algorithms. In step S1433, the content between scan lines 469 to 486 of the active region is replaced with blank data. In step S1435, information indicating that a quantity of active scan lines is 468 is stored in the active region. With reference to FIG. 13, in step S1435, all enabled bits in SAV codes of the preceding 468 scan lines of an active region are set to “1”, and all enabled bits in SAV codes of scan lines 469 to the 576 of the active region are set to “0”. In step S1437, the adjusted video frame is output to the control circuits 233 of FIG. 11 for further processing. Note that, in step S1437, the adjusted video frame is also output to the signal output device 250 of FIG. 2.

Methods for adjusting digital video signals, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD player, a DVD recorder, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to different components by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for adjusting digital video signals, performed by an image generating device to provide images to a display module, the display module comprising a first signal adjustment unit, a second signal adjustment unit, and a display panel, the method comprising:
receiving a first video frame;
adjusting the content of an active region of the first video frame to a second video frame in response to the second signal adjustment unit;
directing the display module to prevent adjustment of the second video frame by the first signal adjustment unit for generating a display video frame displayed on the display panel; and
outputting the second video frame to the display module,
wherein the first signal adjustment unit reduces a resolution of a received video frame to generate a reduced video frame by alternately dropping half of the scan lines of the active region of the video frame, and repeatedly dropping scan lines after at least two scan lines until reaching the last scan line of the active region of the reduced video frame.

2. The method as claimed in claim 1 wherein the first video frame conforms to a first TV system, the first signal adjustment unit is initially configured to adjust a received video frame upon detecting that the received video frame conforms to the first TV system, and the second signal adjustment unit is initially configured to adjust a received video frame upon detecting that the received video frame conforms to a second TV system, wherein the first TV system is the PAL (Phase Alternating Line) system, and the second TV system is the NTSC (National TV Standards Committee) system.

3. The method as claimed in claim 1 wherein, in the directing step, the display module is directed to use the second signal adjustment unit to adjust the second video frame for generating the display video frame, and the second signal adjustment unit reduces a resolution of the second video frame to generate a third video frame by alternately dropping half of the scan lines of the active region of the video frame, and drops a certain number of scan lines including or subsequent to the beginning scan line of the active region of the third video frame, and a certain number of scan lines including or prior to the last scan line of the active region of the third video frame to generate the display video frame.

4. The method as claimed in claim 1 wherein, in the directing step, the display module is directed to use the second signal adjustment unit to adjust the second video frame for generating the display video frame, and the second signal adjustment unit reduces a resolution of the second video frame to generate the display video frame by alternately dropping half of the scan lines of the active region of the video frame.

5. The method as claimed in claim 1 wherein, in the directing step, further comprises writing information indicating that the second signal adjustment unit is enabled to process the second video frame to a register of the display module, whereby ensuring the second video frame to be transferred to the second signal adjustment unit.

6. The method as claimed in claim 1 wherein, in the directing step, further comprises storing information indicating a quantity of active scan lines of the active region of the second video frame in the second video frame, whereby ensuring the second video frame to be transferred to the second signal adjustment unit.

7. The method as claimed in claim 1 wherein, in the adjusting step, further comprises re-scaling the content of scan lines of a first quantity in the active region of the first video frame into scan lines of a second quantity in the active region of the second video frame, and the first quantity is greater than the second quantity.

8. An apparatus for adjusting digital video signals, comprising:
a display module comprising a first signal adjustment unit, a second signal adjustment unit, and a display panel; and
an image generating device coupling to the display module, receiving a first video frame, adjusting the content of an active region of the first video frame to a second video frame in response to a second signal adjustment unit, directing the display module to prevent adjustment of the second video frame by the first signal adjustment unit for generating a display video frame displayed on the display panel, and outputting the second video frame to the display module,
wherein the first signal adjustment unit reduces a resolution of a received video frame to generate a reduced video frame by alternately dropping half of the scan lines of the active region of the video frame, and repeatedly drops scan lines after at least two scan lines until reaching the last scan line of the active region of the reduced video frame.

9. The apparatus as claimed in claim 8 wherein the first video frame conforms to a first TV system, the first signal adjustment unit is initially configured to adjust a received video frame upon detecting that the received video frame conforms to the first TV system, and the second signal adjustment unit is initially configured to adjust a received video frame upon detecting that the received video frame conforms to a second TV system.

10. The apparatus as claimed in claim 9 wherein the first TV system is the PAL (Phase Alternating Line) system, and the second TV system is the NTSC (National TV Standards Committee) system.

11. The apparatus as claimed in claim 8, wherein the image generating device directs the display module to use the second signal adjustment unit to adjust the second video frame for generating the display video frame, and the second signal adjustment unit reduces a resolution of the second video frame to generate a third video frame by alternately dropping half of the scan lines of the active region of the video frame, and drops a certain number of scan lines including or subsequent to the beginning scan line of the active region of the third video frame, and a certain number of scan lines including or prior to the last scan line of the active region of the third video frame to generate the display video frame.

12. The apparatus as claimed in claim 8, wherein the image generating device directs the display module to use the second signal adjustment unit to adjust the second video frame for generating the display video frame, and the second signal adjustment unit reduces a resolution of the second video frame to generate the display video frame by alternately dropping half of the scan lines of the active region of the video frame.

13. The apparatus as claimed in claim 8, wherein the image generating device writes information indicating that the second signal adjustment unit is enabled to process the second video frame to a register of the display module, ensuring that the second video frame is transferred to the second signal adjustment unit.

14. The apparatus as claimed in claim 8, wherein the image generating device stores information indicating a quantity of active scan lines of the active region of the second video frame in the second video frame, ensuring that the second video frame is transferred to the second signal adjustment unit.

15. The apparatus as claimed in claim 14, wherein the display panel comprises 234 lines for display of the display video frame, and the quantity of active scan lines of the active region of the second video frame is 480, or 468.

16. The apparatus as claimed in claim 8, wherein the image generating device re-scales the content of scan lines of a first quantity in the active region of the first video frame into scan lines of a second quantity in the active region of the second video frame, and the first quantity is greater than the second quantity.

17. The apparatus as claimed in claim 16, wherein the display panel comprises 234 lines for display of the display video frame, the first quantity is 576, and the second quantity is 480, or 468.
